(19) United States
(12) Patent Application Publication
(10) Pub. No.: US 2015/0066629 A1
(43) Pub. Date: Mar. 5, 2015

(54) SYSTEMS, METHODS, AND MEDIA FOR ENHANCING FORM SIGNUP YIELDS ON WEBSITES

(71) Applicants: Bradley J. Seiler, Chicago, IL (US); Howard S. Yeh, Miami, FL (US)

(72) Inventors: Bradley J. Seiler, Chicago, IL (US); Howard S. Yeh, Miami, FL (US)

(21) Appl. No.: 14/015,911

(22) Filed: Aug. 30, 2013

(51) Int. Cl. G06Q 30/02

(52) U.S. Cl. CPC G06Q 30/0244
USPC 705/14.43

(57) ABSTRACT

Systems, methods, and media for enhancing form signup yields on websites are provided herein. Methods may include generating a floating callout tab at a location on a webpage, generating a message frame proximate the floating callout tab in response to selection of the callout tab, the message frame comprising a message configured to entice selection of the message frame or callout tab by an end user of the webpage, generating a modal window in response to selection of the message frame or callout tab, the modal window configured to allow the end user to input information into the form provided. The methods also include tracking these steps, analyzing the information generated from the events and optimizing future events.

### FIELD OF THE TECHNOLOGY

Embodiments of the disclosure relate to website optimization. More specifically, but not by way of limitation, the systems and methods provided herein may be utilized to create optimized signup forms for websites, such as newsletters and customer contact forms. The present technology contemplates a dynamic optimization process that learns from form signup events and automatically tailors future form signup events to increase form signup yields.

### BACKGROUND OF THE DISCLOSURE

Websites often include various means for collecting information from end users in order to facilitate the delivery of future communications with the end users. Specifically, these means include, but are not limited to, signup forms that allow end users to request information or opt into delivery of email communications such as newsletters. While various methodologies exist for presenting and delivering signup forms to end users, these methodologies are fixed in nature. That is, signup forms are typically presented to each end user in the same static format. For example, signup forms will include the same layout, design, content, and placement for every end user.

A common instance of such a website signup form is for the opt-in of a user to an email newsletter. Email newsletters are used by thousands of businesses and websites as a means to communicate with their users and prospective customers. Most businesses and websites who engage in email marketing have a goal of growing their “list” of subscribers to their email newsletter. Each new subscriber represents a prospective customer who has “opted in” to receiving content, news, updates and promotions from the email marketer. Email newsletters are most commonly provided by third-party software providers. These software providers typically provide a web-based turnkey solution, which include email serving and reporting, list management, and email compliance. Web-based newsletter signup forms are usually provided for free by the email software providers. They offer different form design templates, and varying degrees of build-it-yourself features. These forms are generally provided as HTML code to be placed directly onto the email marketer's website.

Another common instance of a website signup form is the online contact form that is found on “Contact Us” page of websites. “Contact Us” pages are standard on websites of all varieties in order to allow website users to communicate directly with the website. Many websites may incorporate a contact form by placing standard, open-source website code directly onto the website's “Contact Us” page.

### SUMMARY OF THE DISCLOSURE

According to some embodiments, the present technology may be directed to methods of website optimization system for increasing electronic form signup yield: (1) for each of a set of website visits: (a) generating a floating callout tab at a location on a webpage; (b) generating a message frame proximate the floating callout tab in response to selection of the callout tab, the message frame comprising a message configured to entice selection of the message frame by an end user of the webpage; (c) generating a modal window in response to selection of the message frame or callout tab, the modal window configured to allow the end user to input information into the form provided; and (d) repeating steps a-c for the set of website visits; (2) tracking form signup events, wherein each form signup event is associated with the location for the floating callout tab, text used in the callout tab, and a message associated with the message frame (3) analyzing the form signup events relative to the set of website visits; and (4) selecting an optimal location for future callout tabs based upon analysis.

According to other embodiments, the present technology may be directed to a website optimization system for increasing electronic form signup yield. In some embodiments, the system comprises: (1) a processor; (2) a memory for storing optimization logic, wherein the optimization logic comprises: (i) a form generator module that is executed by the processor to: (a) generate a floating callout tab at a location on a webpage; (b) determine actuation of the floating callout tab; (c) generate a message frame proximate the floating callout tab in response to selection of the callout tab, the message frame comprising a message configured to entice selection of the message frame by an end user of the webpage; (d) generate a modal window in response to selection of the message frame or callout tab, the modal window configured to allow the end user to input information into the form provided; and (e) repeating steps a-d for the set of website visits; (ii) an event tracking module that is executed by the processor to track form signup events, wherein each form signup event is associated with the location for the floating callout tab, text used in the callout tab, and a message associated with the message frame; and (iii) an optimization module that is executed by the processor to: (A) analyze the form signup events relative to the set of website visits; and select (B) an optimal location for future callout tabs based upon analysis.

According to other embodiments, the present technology may be directed to a method for increasing electronic form signup yield. The method includes: (a) generating for use with a webpage: (1) a callout tab having tab variables that include design and placement on the webpage; (2) a callout prompt that appears when the floating callout tab is selected, the callout prompt comprising prompt variables that includes call-to-action text and variable tooltip text; and (3) a modal window that allows end users to signup for an offering, the modal window having window variables that include design and a variable call-to-action text; (b) for each website visit, dynamically selecting the tab variables, the prompt variables, and the window variables; (c) recording, for each website visit, whether the website visit included a successful or an unsuccessful form signup event, as well as the dynamically selected tab variables, prompt variables, and window variables for the website visit; (d) identifying selected tab variables, prompt variables, window variables, and user session variables that are strongly correlated to successful form signup event; (e) for subsequent web visits, serving the selected tab variables, prompt variables, and window variables that are strongly correlated to successful form signup events.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates an exemplary architecture for practicing aspects of the present technology;

FIG. 2 illustrates an exemplary website optimization system, for use in accordance with the present technology;

FIG. 3 is a flow diagram illustrating the use of various prompts, forms, and frames in a process for enhancing the yield of signup events;

FIG. 4 illustrates a plurality of exemplary floating callout tabs;

FIG. 5 illustrates an exemplary customer website having a plurality of potential vertical placements for a floating callout tab;

FIG. 6 illustrates an exemplary customer website having a plurality of potential horizontal placements for a floating callout tab;

FIG. 7 illustrates the placement of a floating callout tab and a message frame on a website;

FIG. 8 illustrates a modal window in the form of a signup form, which is floating or overlaid on the website of FIG. 7;

FIG. 9 illustrates a signup confirmation page that floats or is overlaid upon the website of FIGS. 7 and 8;

FIG. 10 is an exemplary dashboard that allows users to select variables of an exemplary callout tab;

FIG. 11 is a flowchart of an exemplary method for increasing electronic form signup yield;

FIG. 12 is a flowchart of another exemplary method for increasing electronic form signup yield; and

FIG. 13 illustrates an exemplary computing system that may be used to implement embodiments according to the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally and interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected,” “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

The term “floating” as used herein may refer to not only web objects associated with a web page that visually appear to ‘float’ above the web page, but also to web objects that are placed on a layer of a web page that is distinct from other layers of the web page. In these instances, the web objects may appear to have an aspect of dimensionality such as depth or may appear to be suspended over a portion of the web page.

Generally, the present technology is directed to systems and methods that increase the yield of form-based signup events served by a website. The present technology employs a targeted training and testing process where a plurality of forms may be displayed to end users in a variety of manners. The relative success or failure (e.g., if an end user successfully completes a form) of form signups occurring in response to these various form presentations/permutations may be assessed by evaluating metrics, such as click through or actuation of the various forms. Using knowledge gleaned from the testing process, the present technology can optimize a form or forms for signup events for a website to increase the likelihood that end users will successfully complete the desired forms.

As an example, the present technology may utilize multivariate optimization processes for improving the newsletter signup yield for email marketing clients. This process enables email marketers to more efficiently market the newsletter offering to their website visitors in an effort to grow the size of their newsletter mailing list.

As used herein the phrase “signup yield” is defined as the ratio of “successful signup events” to “website visitors”. Conversely, website visitors that did not successfully signup are considered as a failure or an unsuccessful signup event.

It will be understood that the present technology may be configured to deliver web pages having the described web objects and web forms, in a variety of formats, which may be tailored for compatibility with a wide range of devices. For example, the present technology may provide web pages that include web objects that are configured for display on a laptop computer or a large monitor. Alternatively, web pages and web objects may be configured for display on devices that utilize smaller displays such as mobile phones, tablets, and/or computing pads. The present technology may determine device types by known methods such as device identifiers, device names, and so forth. Also, device types may be inferred from browser client information or from network information that indicates what type of network is being used by a particular device.

Advantageously, the present technology enables email marketers to more effectively grow the size of their email marketing list with intent-driven subscribers culled from their existing base of website traffic. Furthermore, by making their email list acquisition more efficient, email marketers can expect to grow their email list in absolute terms.

Website administrators not experienced in online marketing and user/customer acquisition often do a poor job of initiating a personalized conversation or relationship with their website visitors. This lack of understanding leads to marketing inefficiencies. For a website that is focused on marketing products or services to customers, the goals of such a website often include presenting information about the product or service, as well as solicit a desired action on the part of the website visitor.

Examples of personalized communications include, but are not limited to sales inquiries, a quote request, a customer service request, a newsletter sign-up, an online appointment request and/or an inbound phone call. Achieving a desired outcome would be called a “conversion” for the web marketer. To maximize marketing efforts, website administrators should attempt to maximize the ratio of conversions to website visitors.

Unfortunately, many websites designs are flawed and fail to convert new customers or users. To the extent that the website engages in any form of traffic acquisition, such as advertising, social media marketing, word-of-mouth campaigns, these inefficiencies can be translated into a loss of income, relative to marketing spend wasted.

Furthermore, website administrators that are not experienced in online marketing typically do not have personnel that are capable of quickly executing changes to the website. Executing content changes would require knowledge of HTML to edit pages, as well as access to web servers in order to publish those changes. For a business that is not focused on website development, the time lapse between making website changes of any kind may be years.

Advantageously, the present technology is configured to deliver in a software-as-a-service (SaaS), via a cloud-based website optimization system, various methods for businesses and organizations to increase conversion rate of user actions on their website(s).

In some embodiments, the present technology is configured to serve floating web objects on a client website to generate these user actions, and to have an end-to-end approach to generating user conversions, using, for example, a training, tracking, and optimization logic, as will be described in greater detail below.

These and other advantages of the present technology will be discussed in greater detail below with reference to the collective drawings.

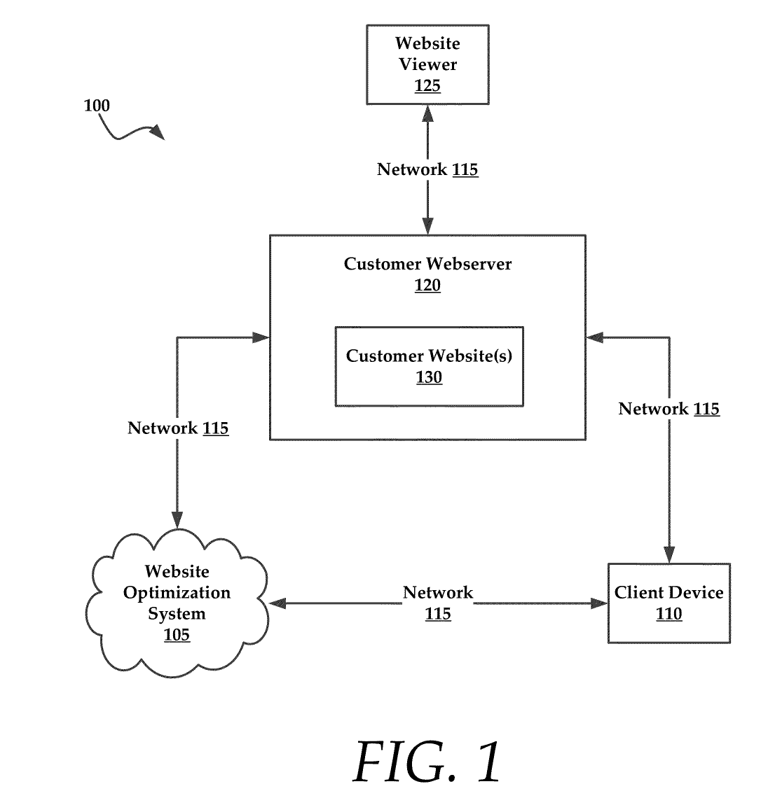

FIG. 1 illustrates an exemplary architecture 100 for practicing aspects of the present technology. The architecture 100 may include a website optimization system, hereinafter system 105, which may be implemented as a webserver or in a cloud-based computing environment. A cloud-based computing environment is a resource that typically combines the computational power of a large grouping of processors and/or that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

In other embodiments, the system 105 may include a distributed group of computing devices such as web servers that do not share computing resources or workload. Additionally, the system 105 may include a single computing system that has been provisioned with executable instructions as described in greater detail below.

End users, such as website administrators, may access and interact with the system 105 via the client device 110 using a web-based interface. The system 105 may communicatively couple with a client device 110 via a network 115. The network 115 may include any one of a number of private and public communications mediums such as the Internet. Indeed, each of the various systems and devices shown in FIG. 1 are communicatively coupled via the network 115, which may include the Internet.

Also, website administrators manage a customer webserver 125 that incorporates and displays the various forms generated by the system 105. Website visitors 125 view and engage with a customer website 130 served by the customer webserver 120.

Advantageously, the system 105 is configured to generate and provide to the customer webserver 120, optimally placed and optimally designed floating objects, which result in higher user conversions than direct/static placements. An appropriate analogy for the website optimization and dynamic form placement processes described herein would be a home that is currently for sale. A direct placement is analogous to placing a “For Sale” sign nailed to the front door. A floating placement built for dynamic adjustment/conversion is akin to placing a larger “For Sale” sign, hanging on a portable post, on the front lawn closest to the street, which is intended to maximize visibility to property-seekers. Additionally, this sign can be size, layout, design, and placement of the sign can be automatically adjusted based upon feedback from property-seekers.

The system 105 utilizes floating placements of web objects plus a standard signup form flow. For example, the placement of a floating callout tab that when actuated causes the display of another frame or form that entices the user. Finally, the display of a floating modal window occurs, which leads to a submission of the signup flow. The system 105 creates a permutation of these tabs, frames, and forms, which can all include their own specific permutations of layout, design, content, and location on the webpage. The system 105 selectively varies each of these objects attributes and monitors conversion rates for each web form and its associated objects. The specific permutation of tabs, forms, frames, and/or windows may be referred to as an object set for the website. In some instances, the system 105 applies standard statistical analysis in order to make algorithmic decisions on winning combinations of forms and attributes.

As mentioned briefly above, the system 105 tracks variations along the conversion path starting with a floating callout tab that is located on a webpage. Actuation of the floating callout tab causes the system 105 to generate and provide to the website a message form/frame that entices the end user into clicking the message form. Actuation of the message form causes the system 105 to generate and provide to the website a floating signup form that is overlaid on the website. One of ordinary skill in the art will appreciate that other combinations of floating web objects and their order of generation and presentation may also likewise be utilized in accordance with the present technology.

In accordance with the present technology, the system 105 selectively varies the attributes of the various objects and tracks conversion rates for each permutation of attributes and/or objects.

Based on observed impact to conversion goals, the system 105 may generate a set of optimized objects that have attributes which are designed to maximize signup event conversions. The system 105 continues to track and refine the object and attributes to ensure that the customer website 130 is maximizing form signup events.

Object variations employed by the system 105 may be based on a library of tabs and forms, as will be described in greater detail below. The system 105 advantageously manages the entire conversion funnel, meaning that experiments and tracking of conversion events can be executed without user-assistance (e.g., website owner action). Also, conversion events are tracked by the system 105 without use of external conversion scripts. This self-contained approach means that the system 105 can operate independently once an initial web code is installed on the customer website 130. Namely, this web code allows control of the customer website 130 by the system 105 including, but not limited to, the placement and tracking of floating web objects, as well as the tracking of website viewer analytics and signup events.

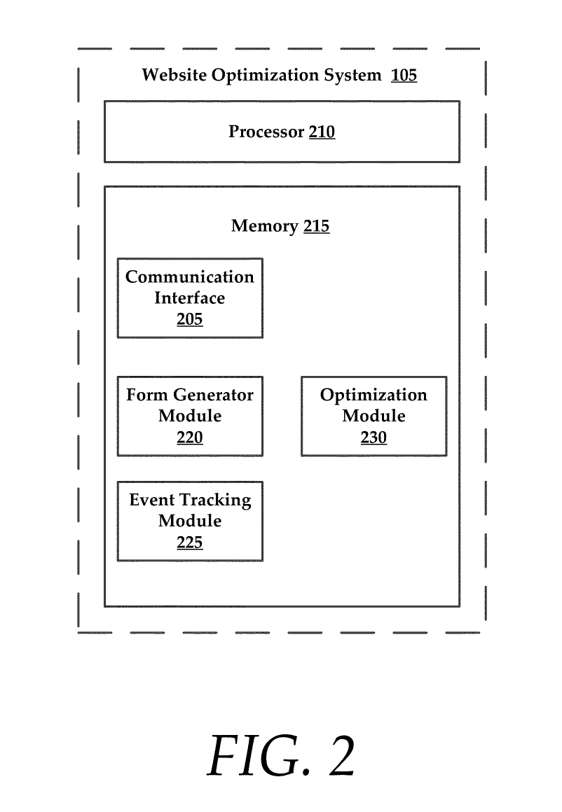

FIG. 2 illustrates additional details regarding the system 105. In some embodiments, the system 105 may comprise a communication interface 205, a processor 210, and a memory 215 for storing executable instructions (e.g., logic) that provide the various functionalities described herein. According to some embodiments, the executable instructions may comprise a form generator module 220, an event tracking module 225, and an optimization module 230. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the may include separately configured web servers. Also, the modules may be provisioned with a cloud as described above.

According to some embodiments the system 105 may utilize the communication interface 205 to communicatively couple with the customer webserver 120 using, for example, an application programming interface (API), a JavaScript, or other type of executable code. In some instances, a linking code is placed on in the HTML code of the customer website. This linking code allows the system 105 to interact with the customer webserver 120 and control the placement of the set of objects placed onto the customer website 125, such as tabs, forms, frames, and windows.

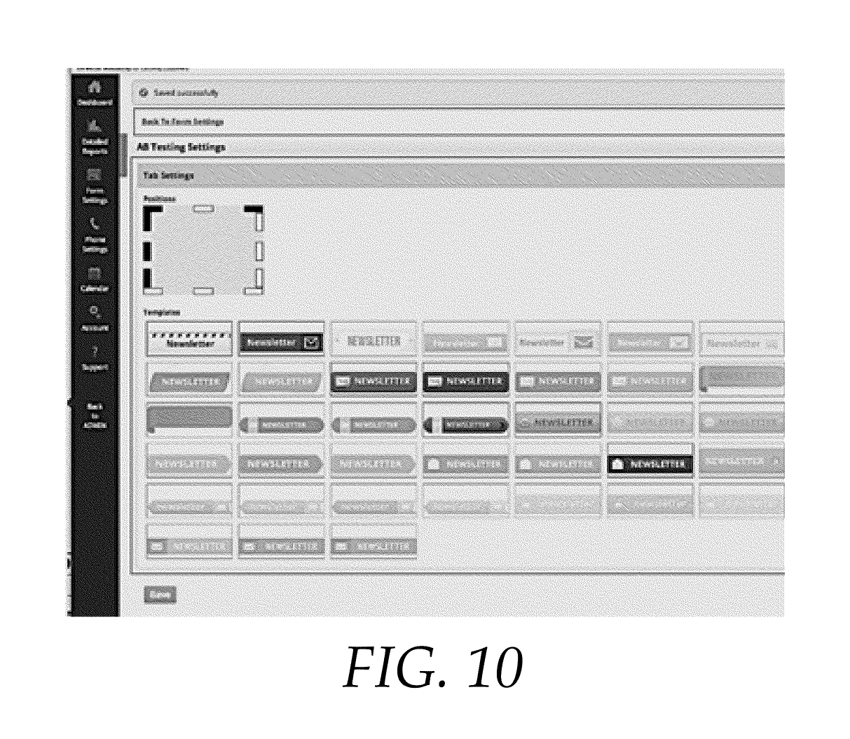

Referring briefly to FIG. 10, initially, the owner or operator of the customer website 125 may utilize a web-based dashboard 1000 to build an initial set of web objects that will be placed on the customer website 125. The dashboard 1000 includes a location selector interface 1005 that allows for selection of one or more desired locations for a floating callout tab. Also, the dashboard 1000 includes a plurality of floating callout tab templates 1010, which are selectable by the end user. While the dashboard 1000 illustrated in FIG. 10 provides a mechanism for defining a floating callout tab, it will be understood that various other web objects for the customer website 125 may also likewise be defined using similar dashboards.

In other embodiments, the system 105 may be configured to generate the web objects for the customer website 125 using, for example, historical or web analytic data about the website or its users. Alternatively, the system 105 may compare the customer website to other customer websites and select an appropriate set of web objects and their attributes from previous successful website designs that are similar to the customer website 125. For example, the system 105 may look for web objects of sports-based ecommerce stores if the customer website 125 is a sports-based ecommerce store.

Once the initial set of web objects has been defined, the form generator module 220 may be executed to generate the appropriate set of web objects and transmit the same for placement on the customer website 125 via code placed into the HTML code of the customer website 125. It will be understood that while HTML has been described, the system 105 is likewise configured to utilize any other code/language that would be known to one of ordinary skill in the art.

According to some embodiments, the form generator module 220 may be configured to selectively vary the attributes of one or more of the web objects that are placed on the customer website 130. The form generator module 220 may vary these attributes in such a way that each unique website visitor is served a unique set of web objects. Alternatively, the form generator module 220 may selectively vary one or more attributes of one or more of the web objects only after a predetermined number of website viewers have visited the customer website.

With regard to the selective variability of the attributes of the various web objects described herein, the following examples will define some non-limiting examples of actions that can be taken by the form generator module 220.

For example, form generator module 220 may selectively vary a layout design for the floating callout tab for each of a set of website visits. Also, the form generator module 220 may selectively vary the call-to-action text of the modal window for each of a set of website visits. Additionally, the form generator module 220 may selectively vary a layout design for the input form within the modal window for each of a set of website visits.

It will be understood that the web objects presented to the website viewers are designed to direct the website viewers to a signup form of some kind. Thus, for each set of web objects, a signup form is presented as the final web object (prior to the signup confirmation page). Again, the selective variability of the web objects is provided to determine which set or sets of web objects (and their attributes) increase successful signup events.

To establish correlations between successful signup events and the web objects/attributes that produced such successful signup events, it is advantageous for the system 105 to track and analyze the web objects presented and the success or failure of the these sets of web objects with regard to signup events.

Therefore, for each website visitor, the event tracking module 225 may observe and track various data points regarding the behaviors of website viewers regarding their interactions with the web objects, as well as whether the website viewer ultimately and successfully completed the signup form that was presented. For each successful signup event, the event tracking module 225 may record the presented web objects and their attributes, as well as analytical information about each web object. For example, the event tracking module 225 may observe how long it took the website viewer to click or actuate the presented web objects, how long it took the website viewer to fill out the signup form, how many times that the website viewer attempted unsuccessfully to complete the signup form, before successful completion, and so forth. These metrics are merely exemplary in nature and should not be construed as being limiting in any way. In a similar manner, the event tracking module 225 also tracks and analyzes unsuccessful/failed signup events.

In some instances, the event tracking module 225 is configured to further evaluate a design for an input (e.g., signup) form within the modal window, text used within the modal window, Internet Protocol-based visitor session details, and other web analytic data about the website visitors.

Using statistical methods for correlating the outcome of successful and unsuccessful signup events, the optimization module 230 may be executed to determine an optimal set of web objects and associated attributes for the customer website. For example, the optimization module 230 may select an optimal layout design for a future floating callout tab based upon analysis of selections made by the set of website visits. Also, the optimization module 230 may select call-to-action text for a future floating callout tab based upon analysis of successful and failed form signup events for the set of website visits. Additionally, the optimization module 230 may select a layout design for a future input form within the modal window based upon analysis of successful and failed form signup events for the set of website visits.

In sum, the optimization process executed by the system 105 identifies a best possible combination of the variables (web objects and attributes) to maximize online signup yield. The system 105 dynamically applies different variables in each conversion step and track results from each variable. Over time, the system 105 can cause the display of variables that demonstrate a stronger correlation to improving signup yield. In some instances, the system 105 tests the interaction of variables with each other to rule out negative correlations, and chooses the top-performing variables for each customer website. It will be understood that the system 105 learns over time from the tracking of variables, such that optimization with data on one optimized user account can be applied to user accounts without data. That is, the system 105 can apply metrics for one customer website to another customer website that has yet to be optimized.

Each optimization decision can depend on the system 105 attaining a statistically significant sample size to reach a conclusion. Provided below are descriptions of main optimization variables that the system 105 may utilize. For example, the system 105 may vary the design of the floating callout prompt. In some instances, the system 105 may vary the placement of the message frame (e.g., callout prompt), and in some embodiments, the system 105 may selectively vary the tooltip text inside the message frame.

Also, the system 105 may selectively vary the design templates for the signup forms (e.g., modal windows), including a size or location for the signup forms. Also the call-to-action text for the signup forms may also likewise be selectively varied by the system 105. In some instances, the signup forms or confirmation forms may include links or advertisements that generate revenue for the customer website owner.

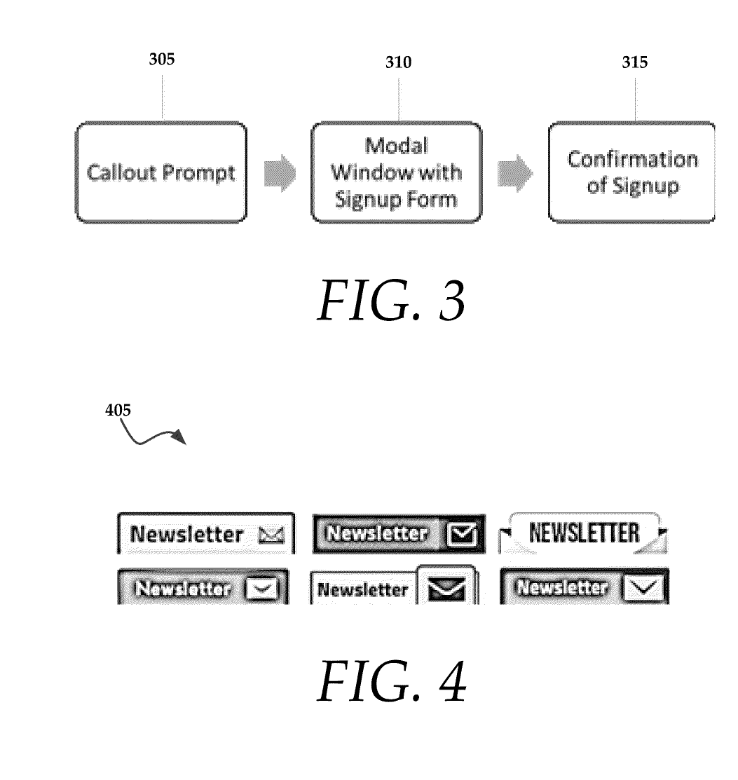

An exemplary object set generated by the system 105 is included in FIG. 3. FIG. 3 also illustrates a process flow using the object set, to increase form signup yields. Namely, a floating callout tab 305 generates and provides to the customer website 130 prior to the generation and provision of a floating modal window with signup form 310. The system 105 then generates and provides to the customer website 130 a confirmation of signup window 315. Again, these specifically described objects and their order of generation and provision are merely exemplary.

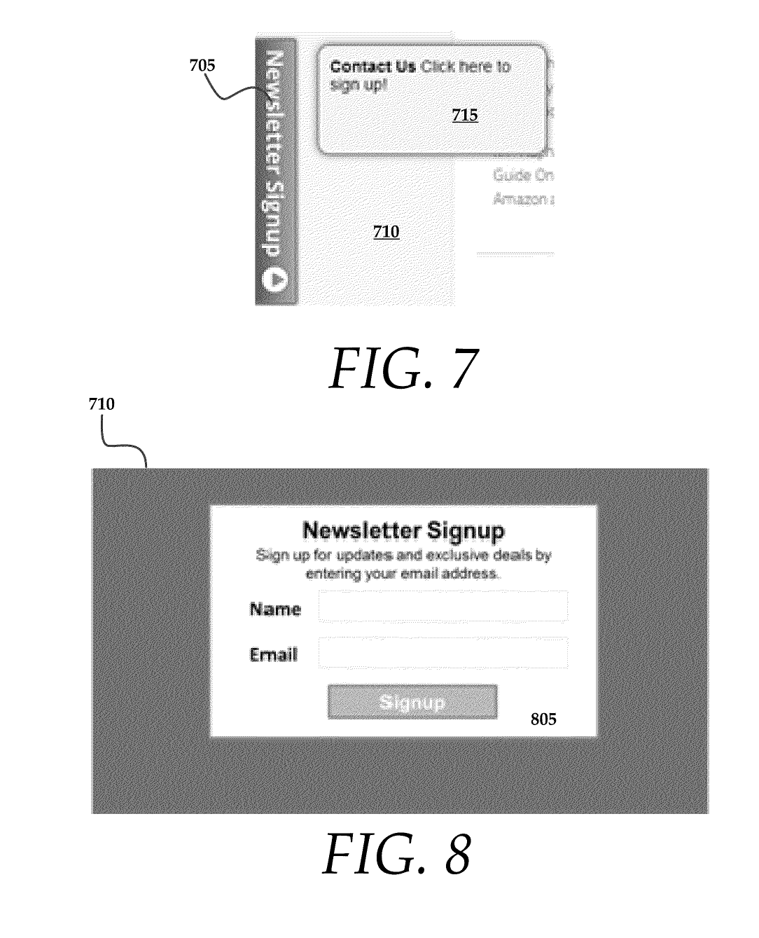

By way of non-limiting example, a set of objects that include a floating callout tab, a modal signup window, and a confirmation window are illustrated collectively in FIGS. 7-9, which will be described in greater detail below.

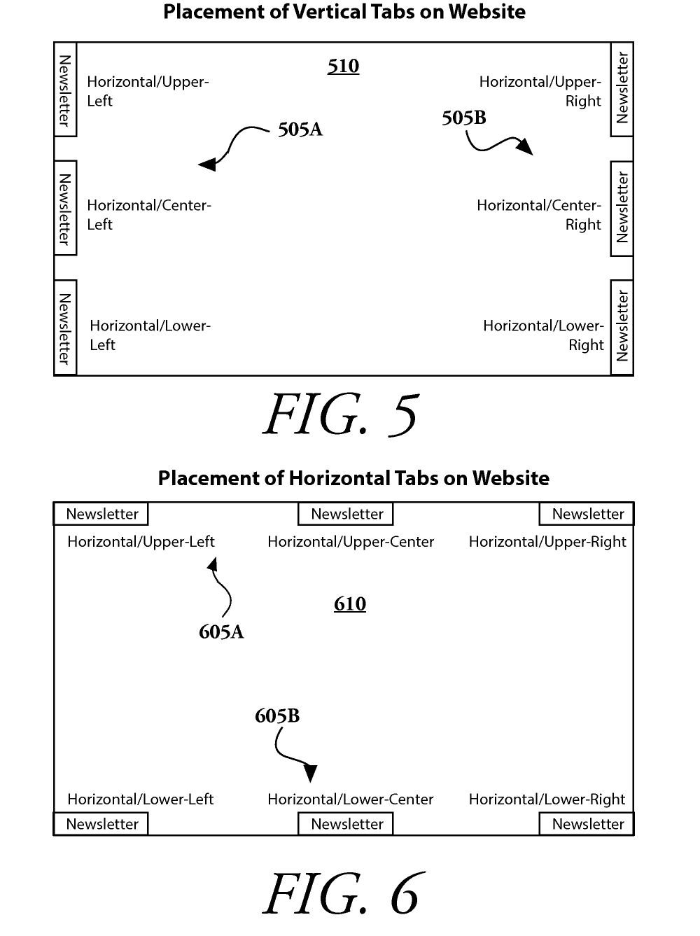

FIG. 4 illustrates a plurality of exemplary floating callout tabs 405. Each of these tabs 405 comprises a layout, a design, and content. FIG. 5 illustrates an exemplary set of possible vertical positions 505A and 505B for a floating callout tab on a website 510. FIG. 6 illustrates an exemplary set of possible horizontal positions 605A and 605B for a floating callout tab on a website 610. By way of example, any of the floating callout tabs 405 of FIG. 4 can be utilized and placed into one of the vertical or horizontal positions of FIGS. 5 and 6.

FIG. 7 illustrates an exemplary floating callout tab 705 that is positioned in a vertical orientation on a webpage 710. The clickable floating callout tab 305 incorporates text such as “Newsletter” appearing on every website pageview. When clicked, the floating callout tab 305 will cause the system 105 to load the newsletter signup form which is the next step in the newsletter signup process. The floating callout tab 305 appears above the site content with placement on the margins of the page. Again, the system 105 employs a variety of designs and colors for the floating callout tab 305.

The goal of the floating callout tab 305 is to quickly draw user attention to the newsletter, and encourage website visitors to take the next step in signing up for the newsletter. When clicked, a newsletter signup form inside of a modal window is loaded on top of the underlying website.

Again, the selection/actuation of the floating callout tab 705 causes the system 105 to display a message frame 715 that is displayed proximate the floating callout tab 705. For example, when a cursor is positioned over the floating callout tab 705 by the website viewer 125, a message will appear in a message frame 715 when a cursor is positioned over an icon, image, hyperlink, or other element in a graphical user interface.

The system 105 may place a default message: “Click here to signup for our newsletter”. However, this message is easily modifiable to a more tailored message. An example of this would be “Sign up to exclusive offers from X Company Carpet Cleaners. Click to continue.” It will be understood that the more effective the tooltip text, the more form views may be generated.

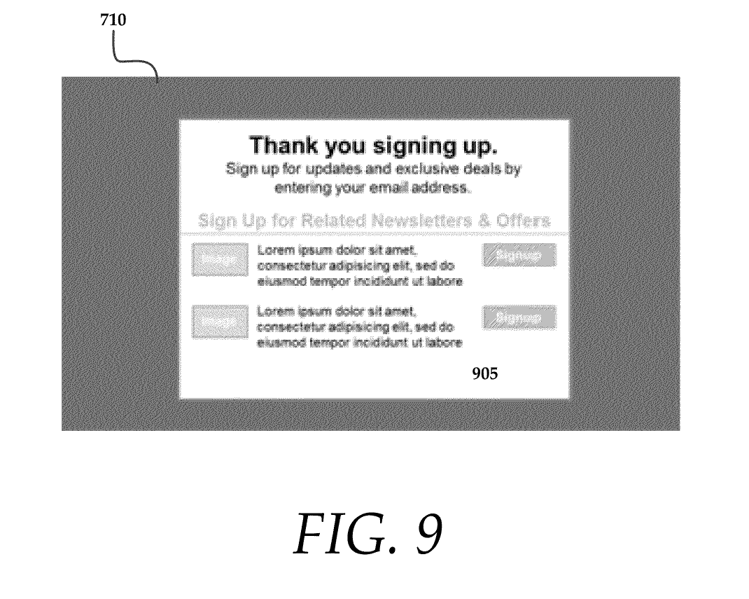

In some instances, the display of the message frame 715 occurs via an animation. For example, the message frame 715 may appear from the left-hand side of the webpage 710 and oscillate or wiggle in place. This behavior, as well as the presence, design, and content included in the message frame 715 entices the website viewer to click on the message frame 715 or callout tab 705. Clicking on the message frame 715 or callout tab 705 causes the display of a floating modal window, such as the modal window of FIG. 8. More specifically, a floating modal window 805 is floated or overlaid upon an underlying webpage, which in this instance is the webpage 710 of FIG. 7. Completion and submission of the floating modal window 805 of FIG. 8 causes the display of a floating confirmation message frame 905, as shown in FIG. 9. The floating confirmation message frame 905 is also overlaid or floated over the webpage 710.

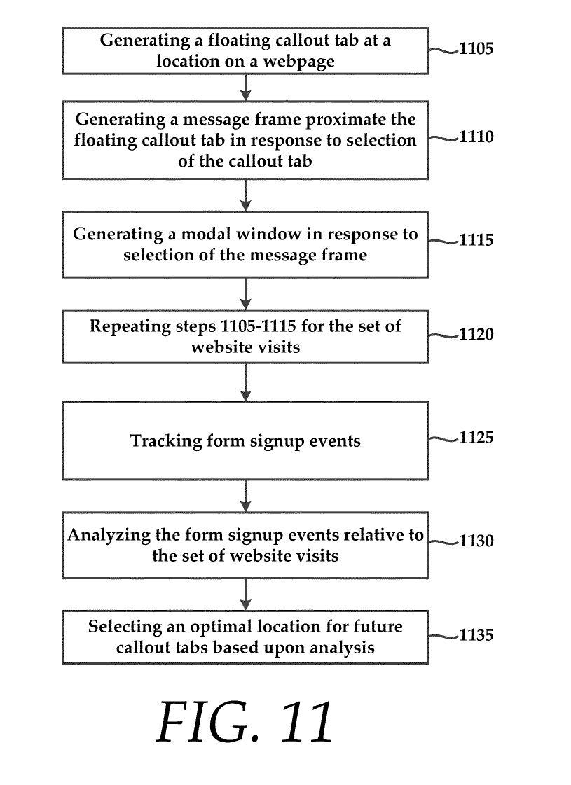

FIG. 11 is a flowchart of an exemplary method of website optimization that increases electronic form signup yield. Initially, the method includes an initial training or testing process. That is, the method includes an initial set of training steps where a set of web objects and attributes are selected for each of a set of website visits. Furthermore, for each of the set of visits, the method includes generating 1105 a floating callout tab at a location on a webpage. Next, the method includes generating 1110 a message frame proximate the floating callout tab in response to selection of the callout tab. Again, the message frame comprises a message configured to entice selection of the message frame by an end user of the webpage.

Additionally, the method includes generating 1115 a modal window in response to selection of the message frame or callout tab. As mentioned previously, the modal window is configured to allow the end user to input information into the form provided. In some instances the method includes repeating 1120 steps 1105-1115 for the set of website visits. Again, the attributes associated with the tabs, frames, and forms may be varied for each visit or the attributes may be consistent across the visits.

In some embodiments, during the training process of steps 1105-1120, the method includes tracking 1125 form signup events. Again, each form signup event is associated with at least the location for the floating callout tab, text used in the callout tab, and a message associated with the message frame. Other metrics may be tracked as described in greater detail above. The method also includes analyzing 1130 the form signup events relative to the set of website visits. Finally, the method includes selecting 1135 an optimal location for future callout tabs based upon analysis.

It will be understood that the actual placement of objects on the customer website may be accomplished using the optimization system 105 described above, where the system 105 generates and places the objects on the customer website. Alternatively, the system 105 may generate and communicate the code for the web objects to the customer website for integration by the website operator.

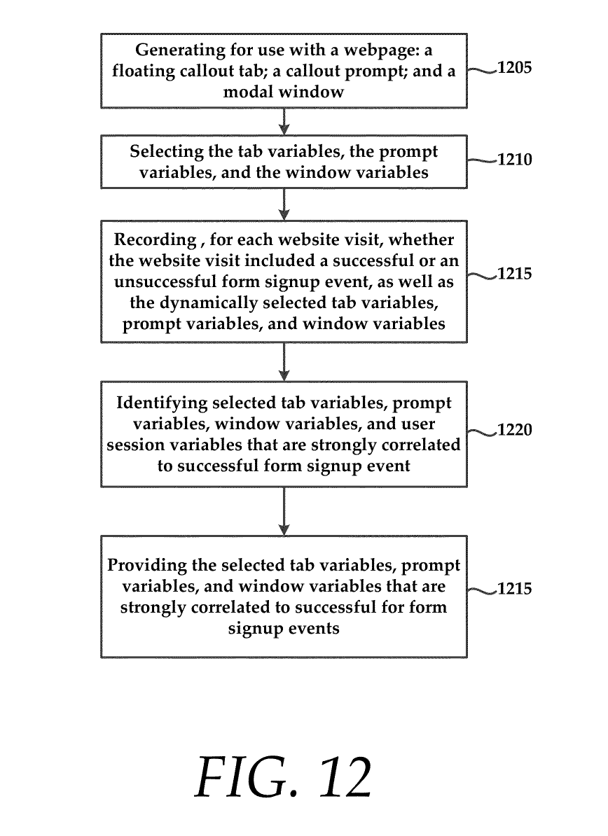

FIG. 12 method for increasing electronic form signup yield. The method includes generating 1205 for use with a webpage: (1) a callout tab having tab variables that include design and placement on the webpage; (2) a callout prompt that appears when the floating callout tab is selected, the callout prompt comprising prompt variables that includes call-to-action text and variable tooltip text; and (3) a modal window that allows end users to signup for an offering, the modal window having window variables that include design and a variable call-to-action text. The method also includes a tracking phase where, for each website visit, the method includes dynamically selecting 1210 the tab variables, the prompt variables, and the window variables. Again, this selection of these various variables may occur as a result of a statistical analysis of variables from successful signup events.

The method also includes recording 1215, for each website visit, whether the website visit included a successful or an unsuccessful form signup event, as well as the dynamically selected tab variables, prompt variables, and window variables for the website visit. After recording, the method may include identifying 1220 selected tab variables, prompt variables, window variables, and user session variables that are strongly correlated to successful form signup event. Finally, the method includes, for subsequent web visits, providing 1225 the selected tab variables, prompt variables, and window variables that are strongly correlated to successful for form signup events.

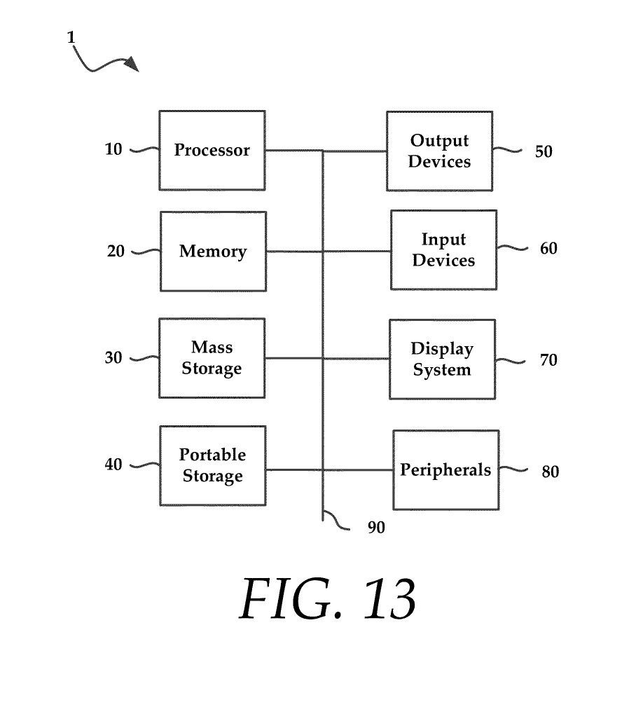

FIG. 13 illustrates an exemplary computing device 1 that may be used to implement an embodiment of the present systems and methods. The system 1 of FIG. 13 may be implemented in the contexts of the likes of computing devices, networks, servers, or combinations thereof. The computing device 1 of FIG. 13 includes a processor 10 and main memory 20. Main memory 20 stores, in part, instructions and data for execution by processor 10. Main memory 20 may store the executable code when in operation. The system 1 of FIG. 13 further includes a mass storage device 30, portable storage device 40, output devices 50, user input devices 60, a display system 70, and peripherals 80.

The components shown in FIG. 13 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 13. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 13 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 13 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for increasing electronic form signup yield using a website optimization system comprising a processor and a memory for storing optimization logic that when executed by the processor performs, the method comprising:
for each of a set of website visits:
(a) generating a floating callout tab at a location on a webpage;
(b) generating a message frame proximate the floating callout tab in response to selection of the callout tab, the message frame comprising a message configured to entice selection of the message frame by an end user of the webpage;
(c) generating a modal window in response to selection of the message frame, the modal window configured to allow the end user to input information into the form provided; and
(d) repeating steps a-c for the set of website visits;
tracking form signup events, wherein each form signup event is associated with the location for the floating callout tab, text used in the callout tab, and a message associated with the message frame;
analyzing the form signup events relative to the set of website visits; and
selecting an optimal location for future callout tabs based upon analysis.

2. The method according to claim 1, further comprising selecting an optimal message for a future message frame based upon analysis of the form signup events.

3. The method according to claim 1, wherein providing the message frame comprises animating the placement of the message frame on the webpage.

4. The method according to claim 1, further comprising selectively varying the location of the floating callout tab for each of the set of website visits.

5. The method according to claim 4, further comprising selectively varying the message of the message frame for each of the set of website visits.

6. The method according to claim 1, wherein the modal window includes a floating web object that floats above the webpage.

7. The method according to claim 1, further comprising selectively varying a layout design for the floating callout tab for each of the set of website visits; and selecting an optimal layout design for a future floating callout tab based upon analysis of selections made by the set of website visits.

8. The method according to claim 1, further comprising selectively varying call-to-action text of the modal window for each of the set of website visits; and selecting call-to-action text for a future floating callout tab based upon analysis of successful and failed form signup events for the set of website visits.

9. The method according to claim 1, further comprising selectively varying a layout design for the input form within the modal window for each of the set of website visits; and selecting a layout design for a future input form within the modal window based upon analysis of successful and failed form signup events for the set of website visits.

10. The method according to claim 1, further comprising loading a confirmation page into the modal window upon occurrence of a successful form signup event.

11. The method according to claim 1, wherein each form signup event is further associated with a design for the input form within the modal window, text used within the modal window, Internet Protocol-based visitor session details, and web analytic data.

12. A website optimization system for increasing electronic form signup yield, the system comprising:
a processor;
a memory for storing optimization logic, wherein the optimization logic comprises:
a form generator module that is executed by the processor to:
(a) generate a floating callout tab at a location on a webpage;
(b) determine actuation of the floating callout tab;
(c) generate a message frame proximate the floating callout tab in response to selection of the callout tab, the message frame comprising a message configured to entice selection of the message frame or callout tab by an end user of the webpage;
(d) generate a modal window in response to selection of the message frame or callout tab, the modal window configured to allow the end user to input information into the form provided; and
(e) repeating steps a-d for the set of website visits;
an event tracking module that is executed by the processor to track form signup events, wherein each form signup event is associated with the location for the floating callout tab, text used in the callout tab, and a message associated with the message frame; and
an optimization module that is executed by the processor to:
analyze the form signup events relative to the set of website visits; and
select an optimal location for future callout tabs based upon analysis.

13. The system according to claim 12, wherein the optimization module is further configured to select an optimal message for a future message frame based upon analysis of the form signup events.

14. The system according to claim 12, wherein the optimization module is further configured to selectively vary the location of the floating callout tab for each of the set of website visits.

15. The system according to claim 14, wherein the optimization module is further configured to selectively vary the message of the message frame for each of the set of website visits.

16. The system according to claim 12, wherein the optimization module is further configured to selectively vary a layout design for the floating callout tab for each of the set of website visits; and select an optimal layout design for a future floating callout tab based upon analysis of selections made by the set of website visits.

17. The system according to claim 12, wherein the optimization module is further configured to selectively vary call-to-action text of the modal window for each of the set of website visits; and select call-to-action text for a future floating callout tab based upon analysis of successful and failed form signup events for the set of website visits.

18. The system according to claim 12, wherein the optimization module is further configured to selectively vary a layout design for the input form within the modal window for each of the set of website visits; and select a layout design for a future input form within the modal window based upon analysis of successful and failed form signup events for the set of website visits.

19. The system according to claim 12, wherein each form signup event is further associated with a design for the input form within the modal window, text used within the modal window, Internet Protocol-based visitor session details, and web analytic data.

20. A method for increasing electronic form signup yield using a website optimization system comprising a processor and a memory for storing optimization logic that when executed by the processor performs a method comprising:
generating for use with a webpage:
a callout tab having tab variables that include design and placement on the webpage;
a callout prompt that appears when the floating callout tab is selected, the callout prompt comprising prompt variables that includes call-to-action text and variable tooltip text; and
a modal window that allows end users to signup for an offering, the modal window having window variables that include design and a variable call-to-action text;
for each website visit, dynamically selecting the tab variables, the prompt variables, and the window variables;
recording, for each website visit, whether the website visit included a successful or an unsuccessful form signup event, as well as the dynamically selected tab variables, prompt variables, and window variables for the website visit;
identifying selected tab variables, prompt variables, window variables, and user session variables that are strongly correlated to successful form signup events; and
for subsequent web visits, providing the selected tab variables, prompt variables, and window variables that are strongly correlated to successful for form signup events.
